(19) United States
(12) Patent Application Publication
(10) Pub. No.: US 2016/0171156 A1
(43) Pub. Date: Jun. 16, 2016

(54) Analysis System of Project Concluding Report Based on Biological Cloud Platform and Method Thereof

(71) Applicant: Beijing Biomarker Technologies Co., Ltd., Beijing (CN)

(72) Inventors: Zheng Hongkun, Beijing (CN); Liu Ge, Beijing (CN); Liu Min, Beijing (CN)

(73) Assignee: BEIJING BIOMARKER TECHNOLOGIES CO., LTD., Beijing (CN)

(21) Appl. No.: 14/883,884

(22) Filed: Oct. 15, 2015

(30) Foreign Application Priority Data
Oct. 17, 2014 (CN) 201410555641.3

(51) Int. Cl. G06F 19/28; G06F 17/30

(52) U.S. Cl. CPC G06F 19/28; G06F 17/30106; G06F 17/30112

(57) ABSTRACT

An analysis system of a project concluding report based on a biological cloud platform and a method. The system includes a concluding report analysis module, for analyzing the concluding report, and integrating and packaging analysis results and raw data into a project file; a presentation module to query all project files and display them in a list, and present a certain project according to a preset style; an integrated analysis module to receive user requests and generate analysis tasks, perform analysis as instructed and transmit the analysis result to the presentation module. The presentation module may also query and read the analysis results corresponding to the project file from the project file list, and display the project file and the corresponding analysis results. By integrating content of the concluding report, raw data and analysis software in one page, users can read and analyze the concluding reports while checking raw data.

### TECHNICAL FIELD

The present invention relates to the field of bioinformatics analysis technics, particularly to an analysis system and method of project concluding report based on biological cloud platform.

### BACKGROUND TECHNOLOGY

With the continuous development of high-throughput sequencing technology, the output speed of biological data is very fast, the output speed of data of the world's second-generation sequencing technology is 13 Pbp per year currently, and is constantly accelerating. The bioinformatics research has formally entered the era of big data.

Except that a lot of computing resources are required to perform bioinformatics analysis, bioinformatics analysis itself is a very complex process. Therefore, the general mode employed by most researchers at the time of analyzation is to provide sample materials and the research purposes to professional bioinformatics analysis companies for analysis, the sequencing and analyzing are completed by these companies. After the completion of the analysis, users obtain a paper of concluding report or a word version (or pdf version) of the concluding report and a large quantity of raw data. Figures or tables obtained by the analysis are listed in the concluding report. The raw data generally cannot be checked in personal computers due to the large quantity of data, or used for subsequent analysis.

However, with the growing demand of analysis by users themselves, cloud computing technology is utilized more and more in the field of bioinformatics analysis. Analysis modes of existing bio-cloud platform are all that users upload data and select the appropriate software for analysis, but these modes do not integrate the concluding report, raw data and subsequent analysis, result in the user can only view the results through figures and tables, cannot perform corresponding analysis during checking the raw data and the concluding report, resulting in the decrease of work efficiency.

### CONTENTS OF THE INVENTION

In order to solve the technical problem in the prior art that work efficiency is reduced due to the fact that the users cannot perform corresponding analysis during checking the raw data and the concluding report while viewing the analysis results.

In one aspect, the present invention provides an analysis system of project concluding report based on biological cloud platform, including concluding report analysis module, user interface module, concluding report presentation module, and integrated analysis module;

the concluding report analysis module is used to analyze the concluding report of each project, integrating and packaging the analysis results and the raw data into a corresponding project file according to the preset format;

the concluding report presentation module is used to query all the project files, display them in a list form, and present a certain project in accordance with the preset style;

the user interface module is used to obtain user requests, and send the requests to the integrated analysis module;

the integrated analysis module is used to generate analysis tasks based on the user requests, performing analysis in accordance with the instructions of the analysis tasks and transmit the analysis result to the concluding report presentation module;

the concluding report presentation module is also used to query and read the analysis results corresponding to the project file from the project file list, and display the project file and the corresponding analysis results.

Optionally, the system further comprises: a cloud database for receiving and storing the project files sent by the concluding report analysis module.

Optionally, the project file includes literal contents, result charts and the result data file of the concluding report;

the user requests include a sequencing data corresponding to the analysis process of the selected project file, analysis software and analysis parameters used, and the user requests are generated according to the list information in the concluding report presentation module.

Optionally, the integrated analysis module includes analysis software module and task scheduling module;

the analysis software module is used to analyze the user requests, and generates analysis tasks based on the obtained report ID the sequencing data, analysis software and analysis parameters according to the concluding report;

the task scheduling module can selects the appropriate analysis software for analysis according to the analysis software in the analysis task.

Optionally, the integrated analysis software also includes an analysis software library for storing various analysis softwares, the task scheduling module can select an appropriate analysis software from the software library during the course of performing the analysis tasks.

Optionally, the user interface module is a user interface module of graphical page WEB.

Optionally, the cloud database is also used to store analysis tasks and analysis results.

Optionally, the preset format is in a SOAP format, the preset style is PLOS One paper style.

In a further aspect, the present invention also provides an analysis method for the project concluding report based on biological cloud platform, comprising:

analyzing the concluding report of each project, integrating and packaging the analysis results and the raw data into a corresponding project file according to the preset format;

querying all the project files, displaying them in a list form, and presenting a certain project according to the preset style;

obtaining user requests, and sending them to the integrated analysis module;

generating analysis tasks according to the user request, performing analysis according to the instructions of the analysis tasks, and display the project file and the corresponding analysis results in the preset style.

Optionally, generating analysis tasks according to the user requests and performing analysis in accordance with the instructions of the analysis tasks including:

analyzing the user requests, and generating analysis tasks based on the obtained report ID, the sequencing data, analysis software and analysis parameters according to the concluding report;

selecting the appropriate analysis software for analyzing according to the analysis software in the analysis tasks.

Allowing users to read concluding report while checking the raw data and performing analytical work by integrating content of traditional concluding report (that is, the project file), raw data and analysis software into a single page using the above analysis system of project concluding report based on biological cloud platform and the method thereof provided in the present invention, work efficiency can be improved. Use of biological cloud platform technology can also reduce the complexity and the threshold for the use of biological information analysis, and users can complete biological information analysis by clicking with a mouse on the graphical interface, and it is easy to operate.

### DESCRIPTION OF DRAWINGS

FIG. 1 is a schematic diagram of composition structure of the analysis system of project concluding report based on biological cloud platform provided in Example 1;

FIG. 2 is a schematic diagram of performing analysis operation on the concluding report by the concluding report analysis module in Example 1;

FIG. 3 is a schematic diagram of all the concluding report information presented by the user interface module in Example 1;

FIG. 4 is a schematic diagram of the concluding report content presented by the concluding report presentation module in Example 1;

FIG. 5 is a schematic diagram of the analysis results presented by the concluding report presentation module in Example 1;

FIG. 6 is a schematic diagram of the raw data presented by the concluding report presentation module in Example 1;

FIG. 7 is a schematic diagram showing that the raw data presented by the concluding report presentation module in Example 1 can be analyzed;

FIG. 8 is a schematic diagram showing by the analysis software module in Example 1 that submitting analysis tasks by using the raw data in the concluding report;

FIG. 9 is a schematic diagram of the analysis results presented by the concluding report analysis module in Example 1;

FIG. 10 is a process flowchart of analysis method of the project concluding report based on biological cloud platform provided in Example 2.

### SPECIFIC EMBODIMENTS

The specific embodiments of the present invention will be described in further detail in conjunction with the accompanying drawings and examples. The following examples are used only for illustrating the invention but are not intended to limit the scope of the invention.

### EXAMPLE 1

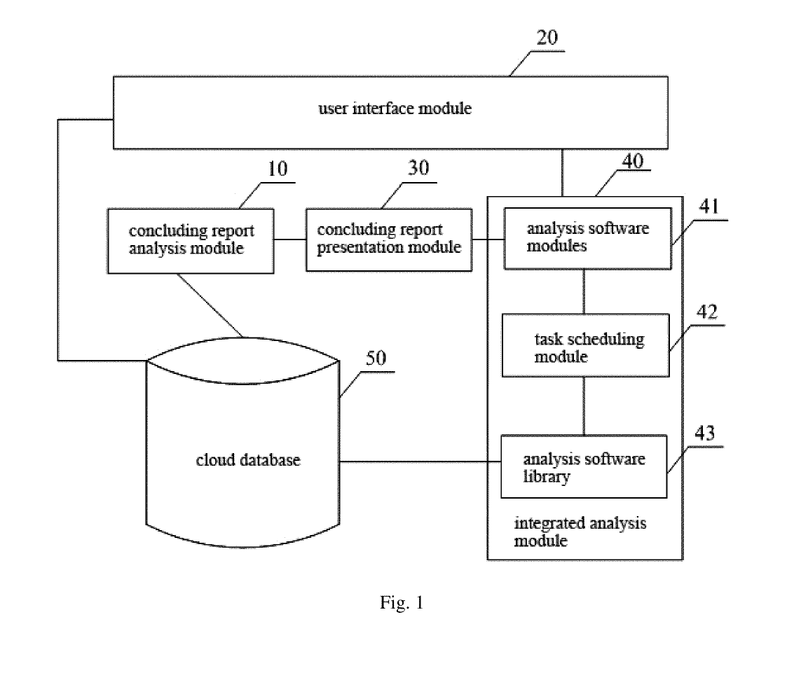

The present example provides an analysis system of project concluding report based on biological cloud platform, the composition schematic diagram shown in FIG. 1, including concluding report analysis module 10, user interface module 20, concluding report presentation module 30, and integrated analysis module 40;

the concluding report analysis module 10 is used to analyze the concluding report of each project, and integrate and package the analysis results and the raw data into a corresponding project file according to the preset format;

the concluding report presentation module 30 is used to query all the project files and display them in a list form, and present a certain project in accordance with the preset style;

the user interface module 20 is used to obtain user requests, and send the requests to the integrated analysis module 40;

the integrated analysis module 40 is used to generate analysis tasks based on the user requests, perform analysis in accordance with the instructions of the analysis tasks, and transmit the analysis result to the concluding report presentation module 30;

the concluding report presentation module 30 is also used to query and read the analysis results corresponding to the project file from the project file list, and display the project file and the corresponding analysis results.

The system provided in the present embodiment is used for solving the problem that is not convenient for users to check project concluding report raw data, and perform subsequent analysis. The project concluding report, raw data and analysis software are combined into a single page by using the user interface, and users can check contents of the concluding report and the raw data in one page, they can also choose sequencing data and analysis software to perform personalized analysis, and the results obtained can also be introduced into subsequent analysis.

Optionally, the project file includes literal contents, result charts and data file in the concluding report; the user requests include the sequencing data corresponding to the selected project file analysis process, the analysis software and the analysis parameters used, and the user requests are generated according to the list information in the concluding report presentation module 30.

Wherein, the preset format of the concluding report contents is SOAP (Simple Object Access Protocol) format. SOAP format is a lightweight, simple, XML-based protocol that is designed to exchange structured and solidified information on the WEB. Since SOAP format can be used in combination with many of the existing internet protocols and formats including HTTP (Hypertext transfer protocol), SMTP (Simple Mail Transfer Protocol), MIME (Multipurpose Internet Mail Extensions), and it also supports a large number of applications from messaging systems to RPC (Remote Procedure Call Protocol), it has a wide range of applicability.

The concluding report presentation module 30 displays the content of the concluding report according to the preset style. Wherein the preset style adopted for display is PLOS One paper style, it can also be other paper styles relating to biological information journals besides PLOS One.

Optionally, the system of the present embodiment further includes: cloud database 50, for receiving and storing the project files sent by the concluding report analysis module 10. In addition, the cloud database 50 is also used to store analysis tasks and analysis results. Cloud database 50 not only stores the contents, analysis tasks and analysis results of the concluding report extracted from the concluding report analysis module, so that subsequently concluding report presentation module is able to display these data simultaneously, to ensure that the raw data (which are the concluding report contents) and analysis tasks can be displayed at the same time when users viewing the concluding report, but also performs analysis work while checking the raw data, which can improve work efficiency.

Optionally, integrated analysis module 40 includes analysis software modules 41 and task scheduling module 42. Specifically, analysis software module 41 is used to analyze the user requests, and generate analysis tasks based on the obtained concluding report ID according to the analysis, the sequencing data, analysis software and analysis parameters corresponding to the concluding report; task scheduling module 42 selects the appropriate analysis software for analysis according to the analysis software in the analysis task, wherein the analysis task is a task of using relevant data in the concluding report to choose appropriate software from the analysis software library to perform analysis at the same time. Therefore, the integrated analysis software also includes analysis software library 43 for storing various analysis software, task scheduling module 42 can select an appropriate analysis software from the analysis software library 43 during the course of performing the analysis tasks. The relevant data in the concluding report are specifically the contents, result charts and data files of the concluding report.

After the above analysis task is completed, the analysis result is displayed by the concluding report presentation module, and is showed below the relevant data in the concluding report. Users can check, download the result and perform additional analysis.

Optionally, the user interface module 20 is a user interface module of graphical page WEB, the use of a graphical user interface can be friendly to user's operation.

Now explanation will be made based on the following embodiments:

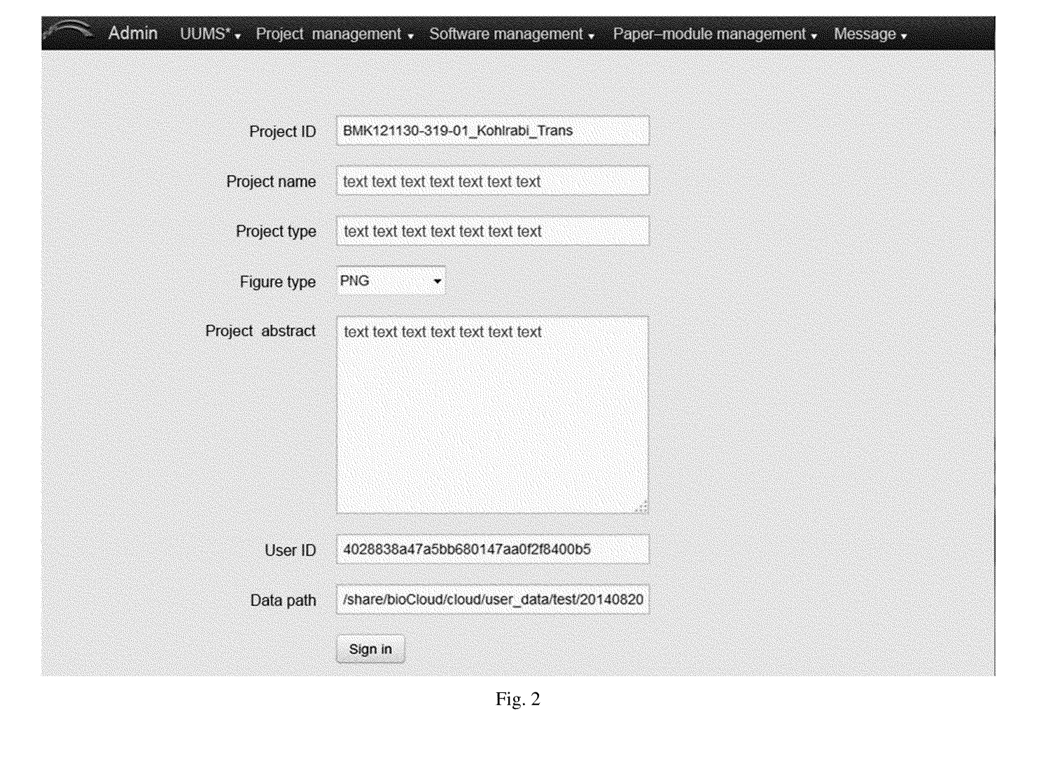

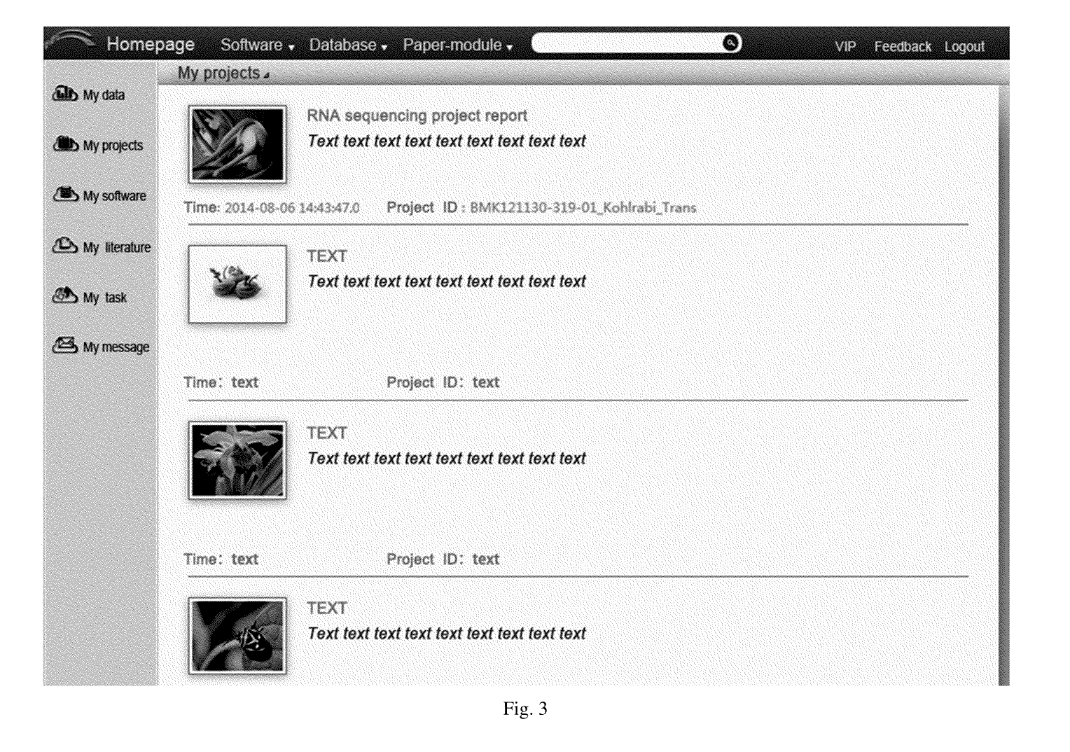

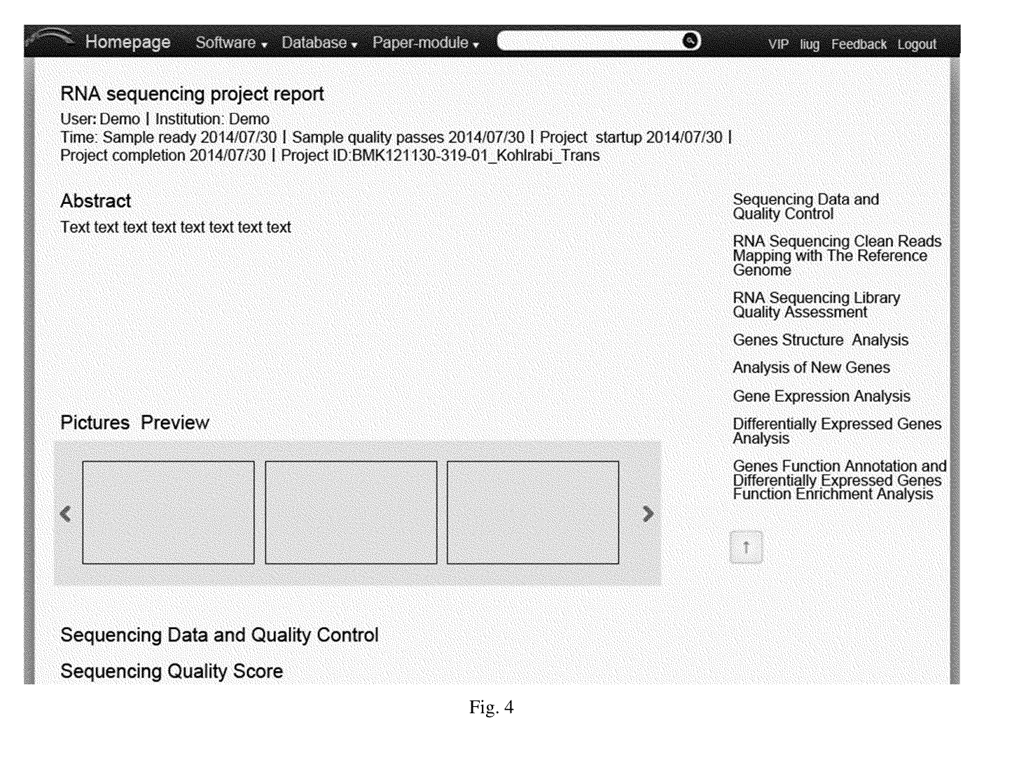

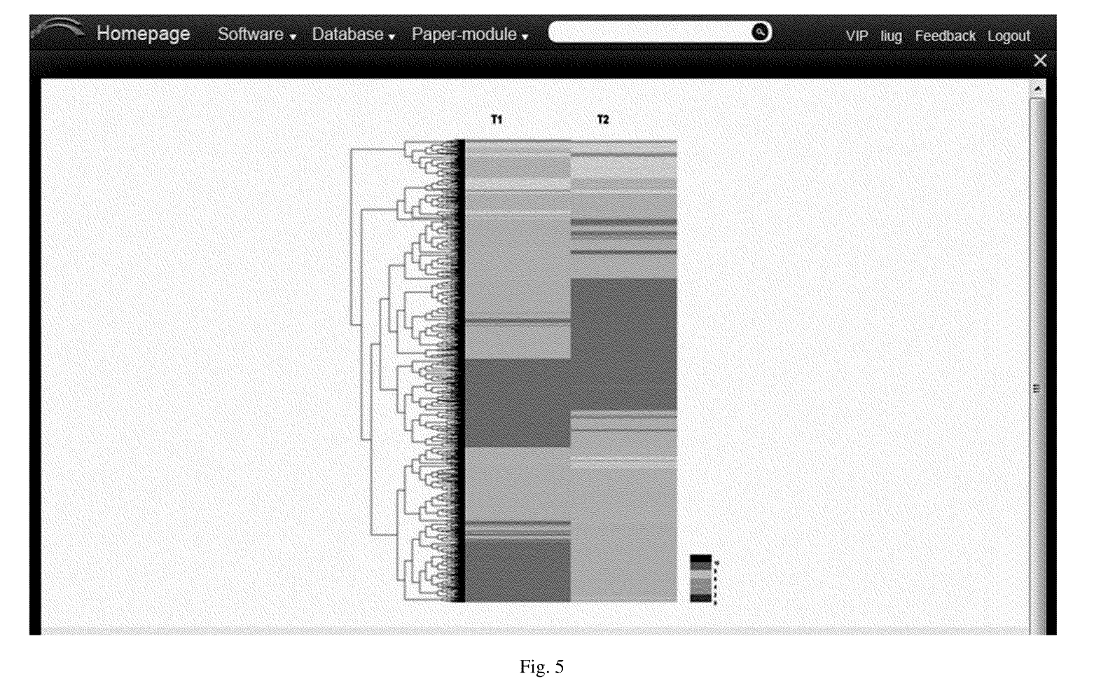

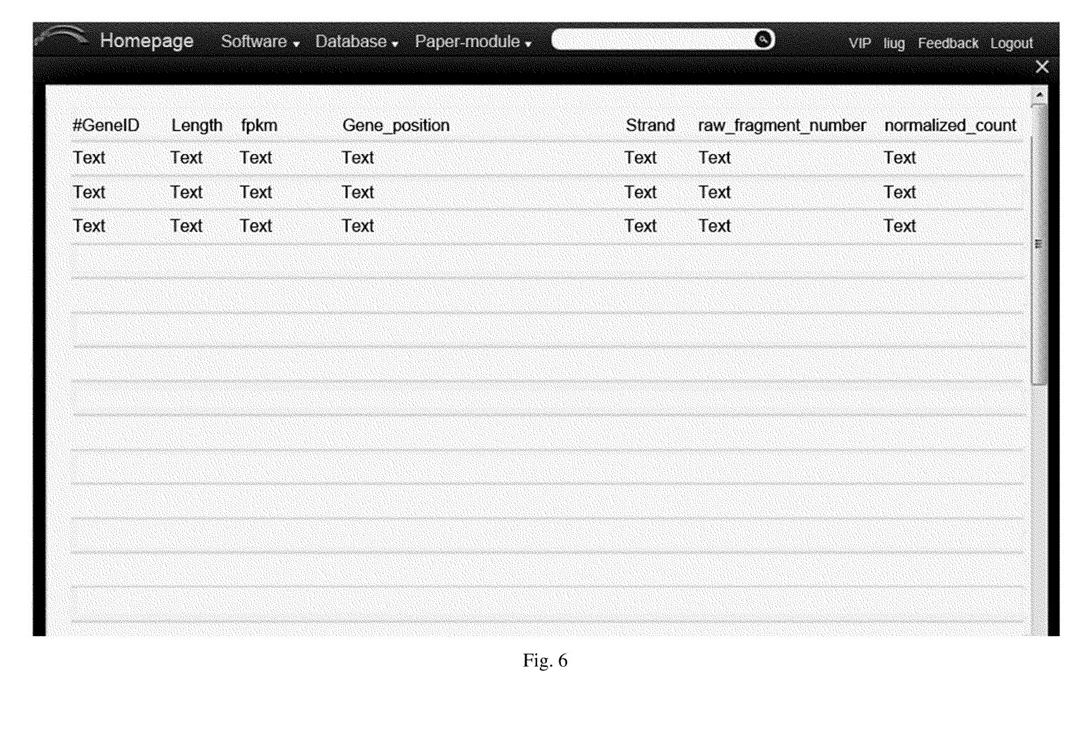

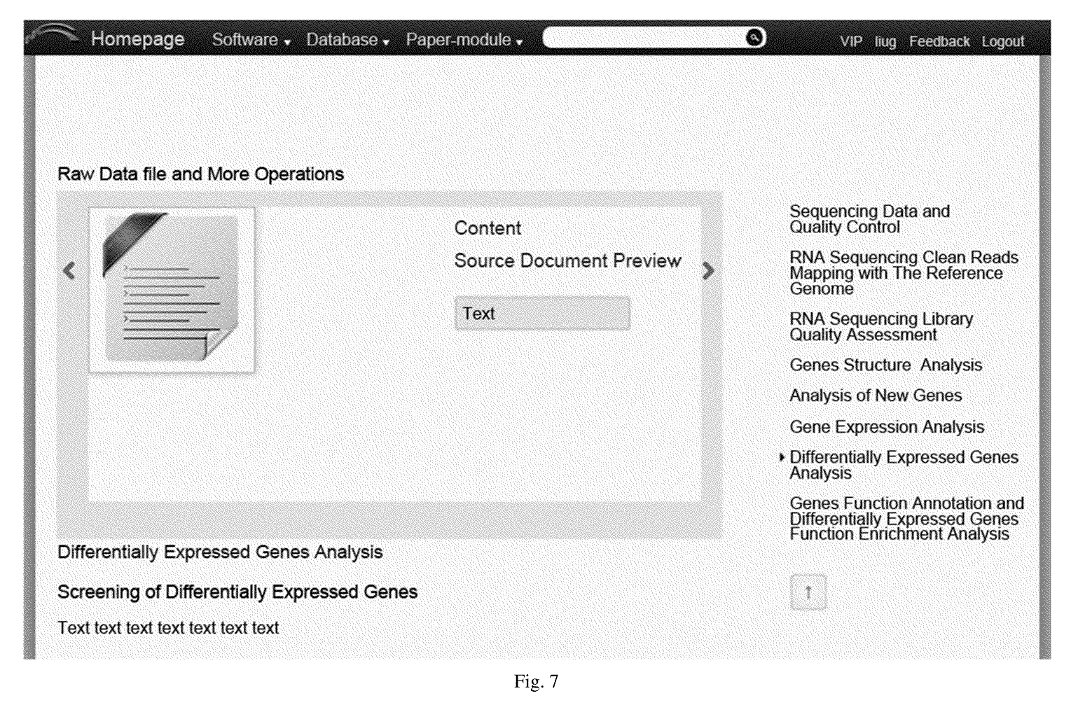

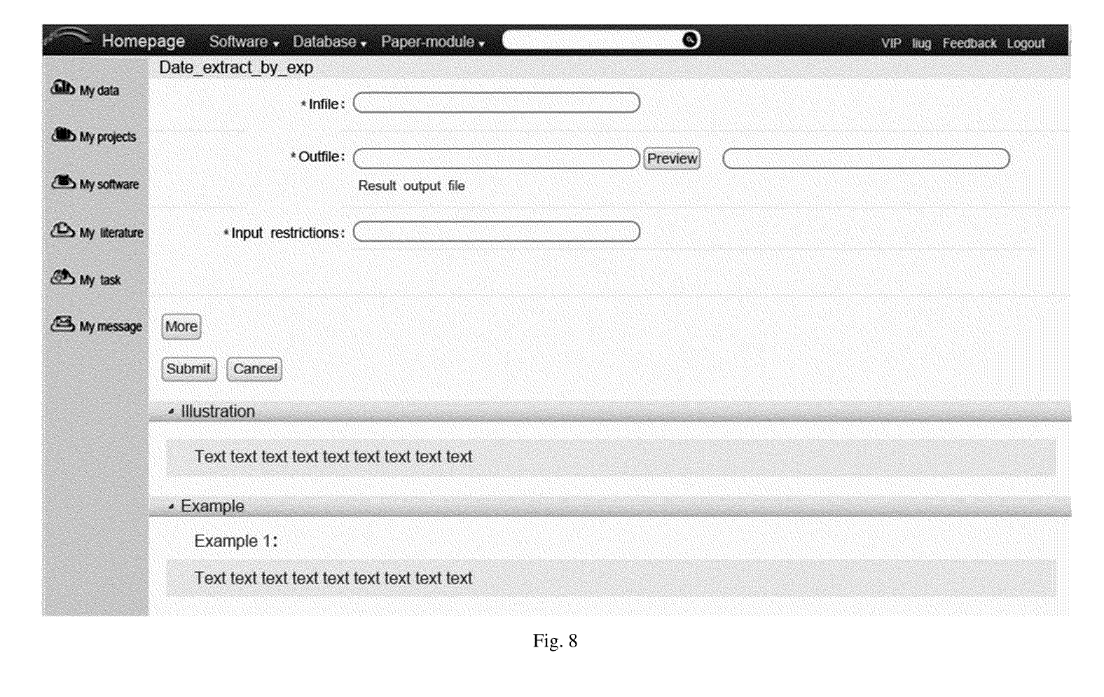

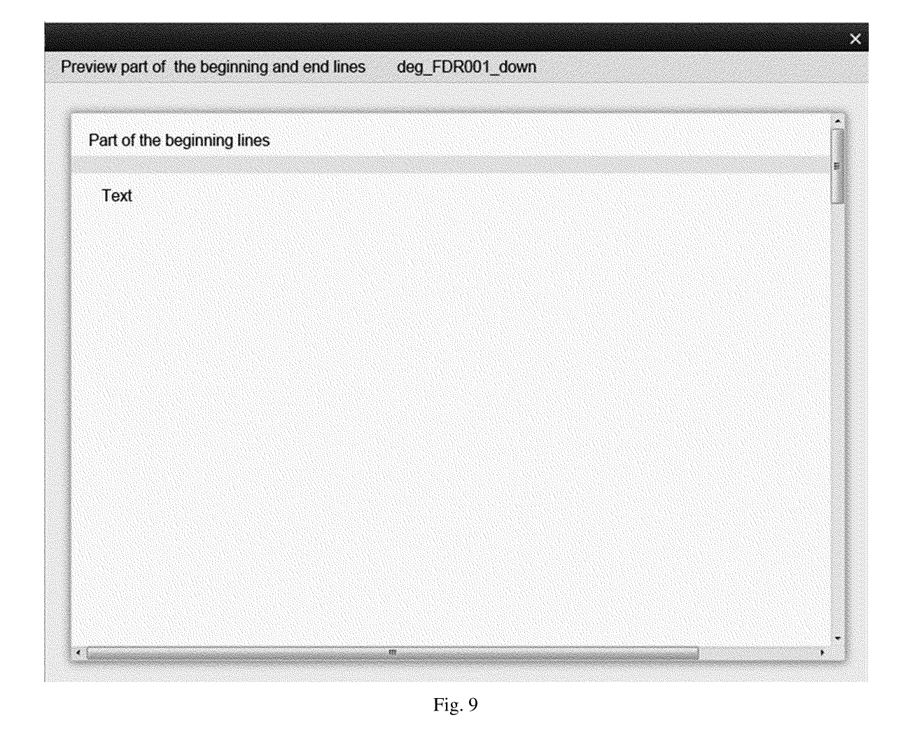

The results, the raw data and other information of the project are integrated in the preset format using concluding report analysis module and stored in the cloud database, as shown in FIG. 2. If the user selects and clicks the desired concluding report to be viewed on the graphical WEB interface, the graphical WEB user interface module will send the ID which the concluding report selected by the user to the concluding report presentation module. After the user logs in the biological cloud platform, the graphical WEB interface module will find out all the items of the user from the cloud database and display them in a list to the user, as shown in FIG. 3. After the user selects a concluding report to view, the concluding report presentation module will present the information of the project file in the preset style after the information is found out from the database, as shown in FIG. 4. The user can view the content of the concluding report and results of the analysis on page, as shown in FIG. 5, and can also view the contents of the raw data involved in the concluding report, as shown in FIG. 6. If a certain raw data needs to be further analyzed, the analysis software beside the raw data which may be used can be selected, as shown in FIG. 7. After clicking the analysis software and access to the analysis software modules, analysis tasks can be submitted, as shown in FIG. 8. After the analysis tasks are completed, analysis results can be viewed, as shown in FIG. 9.

Users can read the concluding report while checking the raw data and perform analytical work by integrating content of traditional concluding report (that is, the project file), raw data and analysis software into a single page, using the analysis system of project concluding report based on biological cloud platform provided in the present example, work efficiency can thus be improved. Using of biological cloud platform technology can also reduce the complexity and the threshold for the use of biological information analysis, users can complete biological information analysis by clicking with a mouse on the graphical interface, and it is easy to operate.

### EXAMPLE 2

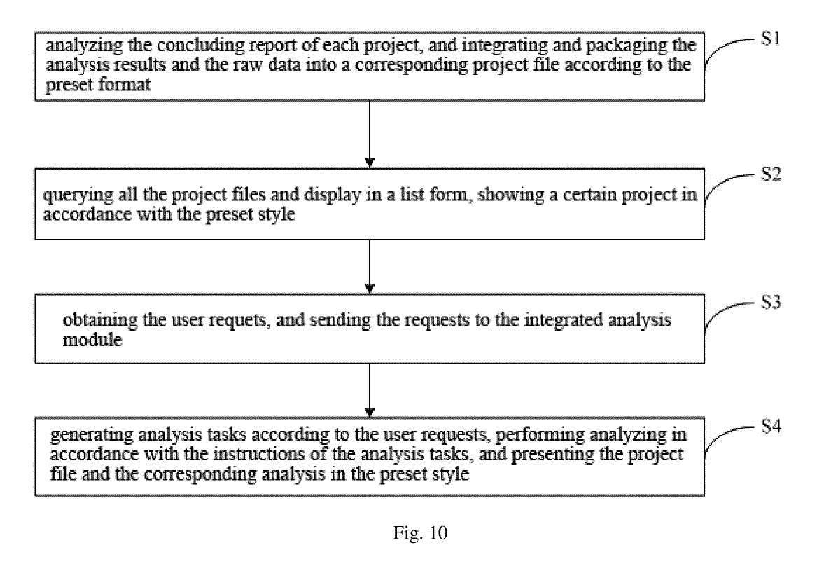

The present example provides an analyzing method for the project concluding report based on biological cloud platform, with process flowchart as shown in FIG. 10, comprising the steps of:

Step S1, analyzing the concluding report of each project, integrating and packaging the analysis results and the raw data into a corresponding project file according to the preset format.

Step S2, querying all the project files, displaying them in a list form, and presenting a certain project according to the preset style.

Step S3, obtaining the user requests, and sending the requests to the integrated analysis module.

Step S4, generating analysis tasks according to the user requests, performing analyzing in accordance with the instructions of the analysis tasks, and presenting the project file and the corresponding analysis results in the preset style.

Optionally, generating analysis tasks according to the user request and performing analysis in accordance with the instructions of the analysis tasks include:

analyzing the user requests, and generating analysis tasks based on the obtained report ID, the sequencing data, analysis software and analysis parameters according to the concluding report;

selecting the appropriate analysis software for analysis according to the analysis software in the analysis task.

With the method provided by the present example, the same technical effect as that in Example 1 can be achieved, and no more explanation will be made here.

The above embodiments are only illustrative of the present invention and not intended to limit the same, a person skilled in the art can also make various changes and modifications without departing from the spirit and scope of the present invention, thus all equivalent technical solutions are within the scope of the present invention, the protection scope of the patent invention is limited by the appended claims.

What is claimed is:

1. An analysis system of project concluding report based on biological cloud platform, comprising: concluding report analysis module, user interface module, concluding report presentation module, and integrated analysis module;
the concluding report analysis module is used to analyze the concluding reports of each project, integrating and packaging the analysis results and the raw data into a corresponding project file according to the preset format;
the concluding report presentation module is used to query all the project files, display them in a list form, and present a certain project in accordance with the preset style;
the user interface module is used to obtain the use requests, and send the requests to the integrated analysis module;
the integrated analysis module is used to generate analysis tasks based on the user requests, analyze in accordance with the instructions of the analysis tasks, and transmit the analysis result to the concluding report presentation module;
the concluding report presentation module is also used to query and read the analysis results corresponding to the project file from the project file list, and show the project file and the corresponding analysis results.

2. The system according to claim 1, characterized in that, further comprising a cloud database for receiving and storing the project files sent by the concluding report analysis module.

3. The system according to claim 1, characterized in that, the project file includes literal contents, result charts and the result data file in the concluding report;
the user requests include sequencing data corresponding to the analysis process of the selected project file, analysis software and analysis parameters used, and the user requests are generated according to the list information in the concluding report presentation module.

4. The system according to claim 3, characterized in that, the integrated analysis module includes analysis software modules and task scheduling module;
the analysis software module is used to analyze the user requests, and generate analysis tasks based on the obtained report ID, sequencing data, analysis software and analysis parameters corresponding to the concluding report;
the task scheduling module selects the appropriate analysis software for analysis according to the analysis software in the analysis task.

5. The system according to claim 4, characterized in that, the integrated analysis software also includes an analysis software library for storing various analysis software, and the task scheduling module can select the appropriate analysis software from the software library during the course of performing the analysis tasks.

6. The system according to claim 1, characterized in that, the user interface module is a user interface module of graphical page WEB.

7. The system according to claim 2, characterized in that, the cloud database is also used to store analysis tasks and analysis results.

8. The system according to claim 1, characterized in that, the preset format is SOAP format, and the preset style is PLOS One paper style.

9. An analyzing method for the project concluding report based on biological cloud platform, comprising:
analyzing the concluding report of each project, integrating and packaging the analysis results and the raw data into a corresponding project file according to a preset format;
querying all the project files, displaying them in a list form, and presenting a certain project in accordance with a preset style;
obtaining the user requests, and sending the requests to the integrated analysis module;
generating analysis tasks according to the user requests, performing analysis in accordance with the instructions of the analysis tasks, and presenting the project file and the corresponding analysis results in the preset style.

10. The method according to claim 9, characterized in that, generating analysis tasks according to the user requests and performing analysis in accordance with the instructions of the analysis tasks include:
analyzing the user requests, generating analysis tasks based on the report ID, the sequencing data, analysis software and analysis parameters according to the concluding report;
selecting an appropriate analysis software for analysis according to the analysis software in the analysis task.
